(19) United States
(12) Patent Application Publication
(10) Pub. No.: US 2013/0120528 A1
(43) Pub. Date: May 16, 2013

(54) VIDEO PROCESSING APPARATUS AND METHOD FOR DETECTING A TEMPORAL SYNCHRONIZATION MISMATCH

(71) Applicant: THOMSON LICENSING, Issy de Moulineaux (FR)

(72) Inventors: Markus Schlosser, Hannover (DE); Jobst Hoerentrup, Hannover (DE)

(73) Assignee: THOMSON LICENSING, Issy de Moulineaux (FR)

(21) Appl. No.: 13/736,248

(22) Filed: Jan. 8, 2013

(30) Foreign Application Priority Data
Jan. 9, 2011 (EP) 12305025.4

(51) Int. Cl. H04N 13/00

(52) U.S. Cl. CPC H04N 13/0051
USPC 348/43

(57) ABSTRACT

A video processing apparatus and a method for detecting a temporal synchronization mismatch between at least a first and a second video stream of 3D video content are provided. A motion vector is determined for a group of pixels in consecutive frames of the left or the right video stream. Further, a disparity between the left and the right video stream is determined for the group of pixels, wherein the motion vector and the disparity are determined for a first number of frames and a subsequent second number of frames of the left and the right video stream.

### FIELD OF THE INVENTION

The invention relates to a method for detecting a temporal synchronization mismatch between at least a first and a second video stream of 3D video content. Further, the invention relates to a video processing apparatus for detecting a temporal synchronization mismatch in 3D video content.

### BACKGROUND OF THE INVENTION

In 3D-video, each eye of the viewer receives its own stream of images. Each image pair in the stream represents the same scene from a slightly different perspective, creating a 3D experience in the human brain during reproduction. Typically, a pair of synchronized cameras is used for capturing stereoscopic 3D video content. One camera captures the images for the left eye, while the other camera captures the images for the right eye. In this context, 3D-video content includes stereoscopic and multi-view video content and is also referred to as stereoscopic video content.

An object in the real word is projected onto different positions within the corresponding camera images. If the parameters for the stereo camera setup are known and the displacement between corresponding points in the stereo images belonging to one and the same object in the real word can be determined, the distance between the real world object and the stereo camera equipment, i.e. the depth of the object, may be calculated by triangulation. The displacement between corresponding points in the stereo images is commonly referred to as disparity.

To produce high quality 3D video content, the stereo cameras must be tightly synchronized so that each pair of images, i.e. the image or frame taken by the left camera and a corresponding image or frame taken by the right camera, are taken at the same moment in time. Otherwise, camera motion and moving objects in the captured scene will lead to additional erroneous disparities.

Human observers are well known to be very sensitive to even small amounts of any vertical disparities, which are by definition erroneous. However, altered or erroneous horizontal disparities can also lead to severe distortions in reproduction of 3D video content. Further, an erroneous disparity between a left and a right picture can lead to conflicts between monocular occlusions and stereoscopic placement cues as well as hyper-convergence or -divergence. These issues can easily lead to an unpleasant viewing experience similar to erroneous vertical disparities, especially as motion in films tends to be more pronounced in the horizontal direction.

In order to provide tight camera synchronization, stereo cameras are usually equipped with a “genlock” or “sync” input through which a central timing generator unit can send a common sync-signal to each of the cameras to trigger the two capturing processes in a synchronous manner. Nevertheless, a lot of 3D-content suffers from insufficient synchronization. The reasons are manifold and range from hardware failures and tolerances to operator mistakes and editing errors.

As a consequence, proper synchronization in the final stereoscopic video content is one critical area to take care of when producing high quality 3D-video content. According to the prior art, quality inspection with respect to synchronization errors is performed manually, in most cases. However, this is a costly and time consuming process because the 3D video content has to be inspected by an operator and the synchronization mismatch has to be determined manually.

Document U.S. Pat. No. 6,340,991 B1 relates to a camera system and a method for synchronization of video frames of a moving object captured from a plurality of video cameras. A first mathematical model of the motion of said object is derived by processing a sequence of video frames of the left channel of stereoscopic video content. A second mathematical model of the motion of said object represented by a second sequence of video frames of the right channel is derived by processing this second sequence of video frames. The first mathematical model is compared to the second mathematical model in order to calculate a time difference between the left and right channel. However, estimation of synchronization mismatch based on mathematical models of motion is restricted to rigid objects showing no deformations. Further, this method suffers from low accuracy and demands for high computational effort.

Accordingly, there is a need for a more efficient, automatic or semi-automatic inspection, allowing detecting a synchronization mismatch in 3D-video content.

### SUMMARY OF THE INVENTION

It is an object of the invention to provide an improved video processing apparatus and an improved method for detecting a temporal synchronization mismatch between at least a first and a second video stream of 3D video content.

In one aspect of the invention, a method for detecting a temporal synchronization mismatch between at least a left and a right video stream of 3D video content is provided. A motion vector for a group of pixels is determined in consecutive frames of the left and/or right video stream. A group of pixels may be an arbitrary number of pixels ranging from a single pixel to all or nearly all pixels of the respective frame. For example, the determination of a motion vector may be performed based on a point to point correspondence between frames of the left and/or right video stream. Further, a disparity between the left video stream and the right video stream is determined for said group of pixels. The motion vector and the disparity are determined in a first number of frames and in a subsequent second number of frames. Within the context of the specification, a number of frames may be an arbitrary number of frames in principle. However, at least two consecutive frames per number of frames will be necessary for determination of a motion vector. For a more accurate determination of motion vectors, it is preferable to analyze a plurality of frames. The motion vector in the first number of frames is compared with the motion vector in the second number of frames. Upon detection of a variation of the motion vector, the disparity which has been determined for the first number of frames is compared with the disparity which has been determined for the second number of frames. A deviation of the disparity value in the first number of frames and the disparity value in the second number of frames is indicative to the synchronization mismatch.

If cameras of a stereo rig are not perfectly synchronized, the cameras will capture a moving object at different moments in time and at different positions along its trajectory in the real world. Something similar applies to a moving camera rig. For this reason, the displacement of objects or even points in the left and right video stream of 3D video content which is due to the physical offset of the cameras, in other words the true disparity between the left and right picture of a pair of stereo frames, will be superposed by a displacement in the direction of movement. These erroneous disparities are proportional to the apparent speed of an object or feature point as it is visible in the camera images and the synchronization offset. According to aspects of the invention, the temporal displacement within one camera view is compared to the displacement (i.e. the sum of the true and the erroneous disparity) between the different camera views, i.e. between the different frames which are captured by the left and right camera of the stereo rig.

However, in order to eliminate the influence of misalignments of the stereo camera rig as well as of the true disparities, a change in motion will be compared with the corresponding change in disparity. The synchronization offset may be determined for a moving object or for a moving camera rig capturing stationary objects. The method according to aspects of the invention may be performed automatically or semi-automatically. This will speed up the inspection process and lead to savings in time and expenses.

According to an advantageous embodiment of the invention, at least one motion vector and/or the disparity is determined by two dimensional block matching or by feature point tracking. The displacement of the object is preferably determined within the first or within the second video stream of the 3D video content. As far as signal processing is concerned, this task is basically the same as disparity estimation between corresponding images of stereoscopic video content. However, disparity estimation typically has a preferred horizontal search direction. Accordingly, for example a two dimensional disparity estimator based on block matching may be applied. However, this two dimensional “disparity” estimation is computationally demanding and may suffer from ambiguities. Feature point tracking seems to be more suitable and is computationally less demanding, because of the limited number of points which has to be examined. Also a mixture of the two approaches may be applied. The ambiguities of the two dimensional block matching may for example be resolved using descriptors similar to those employed in feature point tracking.

The synchronization mismatch may be determined based on a vertical component of the motion vector and the corresponding disparities, according to another advantageous aspect of the invention. However, this simple determination of the synchronization offset is restricted to detected motion vectors having a vertical component which is substantially greater than zero. Analyzing the vertical component of the disparity has the considerable advantage that 3D video content should ideally not exhibit any vertical disparities. If vertical disparities exist, it is a bad sign anyway. If there are vertical disparities which are due to erroneous synchronization issues, the frame offset, i.e. the temporal synchronization mismatch between the two captured video streams, may be determined with sub frame accuracy. This may be performed by simply dividing the measured vertical disparity between the different camera views through the vertical component of the motion vector, which is for example due to a displacement of an object, between subsequent images of one camera, i.e. between subsequent frames of one video stream.

However, vertical disparities can also exist for other reason, for example due to a misalignment or a convergence of the cameras of the stereo camera rig. However, these disparities may be assumed to be constant in time. Since a deviation in the motion vector and a corresponding deviation of the disparity are used to determine a temporal synchronization mismatch, this static vertical disparity field is disregarded. Alternatively, for a calculation of the temporal synchronization mismatch, the static vertical disparity field may be simply subtracted from the measured values before calculation of the frame offset i.e. before calculation of the synchronization mismatch.

However, vertical motion is typically less common and also smaller than horizontal motion, in most video content. This restricts the applicability and the accuracy of the mentioned analysis of vertical displacements.

According to another aspect of the invention, for a motion vector having a horizontal component which is substantially greater than zero, a type of camera and object movement is determined. Within the context of the specification, a camera movement is a displacement of a camera, for example a tracking shot or dolly shot. Further, a camera movement shall be a camera panning, too. Also a camera zoom which means a zoom in or a zoom out should be referred to as a camera movement. Camera movements may be determined by analyzing the vector field for objects or points in the captured frames. There are well known typical vector fields for each of the above-mentioned camera movements. For example, for a tracking shot or a camera pan, nearly all pixels move with a same speed and direction.

If a camera pan is detected, the synchronization mismatch may be determined by dividing the deviation in the horizontal component of the disparity by the variation of the horizontal component of the motion vector. In an ideal case of a camera pan, there is a horizontal rotation of the camera around the focal point and all pixels in the captured frames move with the same speed and disparities stay constant. Therefore, any erroneous change in disparity will be related to a synchronization offset and may be determined as easily as for vertical motion.

Further, according to another aspect of the invention, if the motion vector has a horizontal component which is substantially greater than zero and the determination of the camera movement indicates a horizontal camera displacement, for example a tracking shot, the synchronization mismatch is determined by dividing a product of the deviation in disparity and a base line of a stereo camera rig which has been applied for capturing the 3D content by the product of a speed of the camera movement and the disparity in the first number of frames. For a pure horizontal translation of the camera rig, the synchronization offset has the same effect as a change in the base line between the two cameras of the stereo camera rig. A relative change in disparity is therefore related to a virtual change in the base line via the speed of the camera motion and the synchronization offset. For example, if the disparities are reduced by 10%, the camera motion multiplied with a synchronization offset will be equal to 10% of the base line between the cameras of the stereo camera rig.

According to another aspect of the invention, for a motion vector having a horizontal component which is substantially greater than zero, a type of object movement is determined. This object movement may be determined by analyzing the vector field. Typically, a limited group of pixels in a certain area is moving while the remaining pixels are at rest. If the object movement is a fronto parallel movement, the synchronization mismatch is determined by dividing the variation of the horizontal disparity by the deviation of the horizontal component of the motion vector of the object.

It is often possible to determine the synchronization mismatch by assuming that the true change in disparity between two consecutive images of one video stream is negligible when compared to the erroneous change in disparity which is caused by the temporal synchronization mismatch. A fronto parallel movement may be assumed if the change in size of an object is much smaller than its change in position due to a displacement in the real world. This may be explained by making reference to the geometry of a stereo camera rig. For a stereo camera arrangement of two parallel ideal pinhole cameras, this is explained for example in M. Brown et al.: “Advances in Computational Stereo”, IEEE Trans. on Pattern Analysis and Measuring Intelligence (PAMI), Vol. 25, No. 8, 2003. As a consequence, if the apparent motion of an object is much larger than its change in size, this is even more true for its change in disparity. For such fronto-parallel motion, the disparities may safely be assumed constant.

However, there may be outliers in the determined disparity values. These may be due to an inaccuracy during determination of feature points.

According to further aspects of the invention, a plurality of motions vectors for a plurality of groups of pixels may be determined for consecutive frames of the left and/or the right video stream. Further, a plurality of disparities between the left and/or the right video stream may be determined for said groups of pixels. The motion vectors and the disparities are determined for a first number of frames and for a subsequent second number of frames of the left and the right video stream, respectively. Subsequently, the motion vectors in the first number of frames may be compared with the motion vectors in the second number of frames and a variation of motion vectors may be detected. Upon detection of said variation, the disparities which have been determined for the first number of frames are compared with the disparities which have been determined for the second number of frames and a preliminary synchronization mismatch is determined by comparing the deviation in the respective disparities. To tackle the problem of outliers, a median of said preliminary synchronization offsets is calculated.

The mentioned calculations may be performed on a per-frame basis which means that the disparity value is determined for a pair of stereo images and the motion vector is determined for two subsequent frames within one of the video streams. However, it is also possible to sum up the disparity values for a plurality of frame pairs and to divide this sum by the sum of the motion vectors for a plurality of subsequent frames. The latter offers an averaging effect and will probably lead to more consistent results. Robustness of the determination of the motion and disparity values may again be further improved by calculating a median of the preliminary determined values.

According to another aspect of the invention, a video processing apparatus for detecting a temporal synchronization mismatch between at least a left and a right video stream of 3D video content is provided. The video processing apparatus is configured to determine a motion vector a group of pixels in consecutive frames of the left and the right video stream. Further, the video processing apparatus is configured to determine a disparity for said group of pixels in the left and the right video stream. The motion vector and the disparity are determined for a first number of frames and a subsequent second number of frames of the left and the right video stream, respectively. The motion vector in the first number of frames is compared with the motion vector in the second number of frames. Upon detection of a variation of the motion vector, the video processing apparatus is configured to compare the disparity which has been determined for the first number of frames with the disparity which has been determined for the second number of frames, wherein a deviation of the disparity is indicative to the synchronization mismatch.

Same or similar advantages which have been already mentioned for the method according to aspects of the invention apply to the video processing apparatus according to aspects of the invention in a same or similar way and are therefore not repeatedly mentioned.

### BRIEF DESCRIPTION OF THE DRAWINGS

For a better understanding the invention shall now be explained in more detail in the following description with reference to the figures. It is understood that the invention is not limited to this exemplary embodiment and that specified features can also expediently be combined and/or modified without departing from the scope of the present invention as defined in the appended claims. In the figures:

FIG. 1 is a simplified set of frames illustrating a moving object in a left and a right video stream of 3D video content,

FIG. 2 is a further simplified set of frames illustrating the moving object in a left and right video stream of 3D video content, wherein there is a temporal synchronization mismatch between the left and right video stream,

FIG. 3 is a frame showing a moving object at several time instances in a single comprehensive frame of a left and a right video stream of stereoscopic video content,

FIG. 4 is a further comprehensive illustration of the complex movement, wherein there is a constant horizontal disparity due to a tight synchronization of the left and right camera,

FIG. 5 is a simplified set of frames illustrating the movement of the object of FIG. 3 in a frame sequence, wherein there is a synchronization mismatch between the left and right camera,

FIG. 6 is a further set of simplified frames illustrating an object which starts to move, wherein there is a synchronization mismatch between the left and right camera, and

FIG. 7 is a simplified video processing apparatus.

### DETAILED DESCRIPTION OF PREFERRED EMBODIMENTS

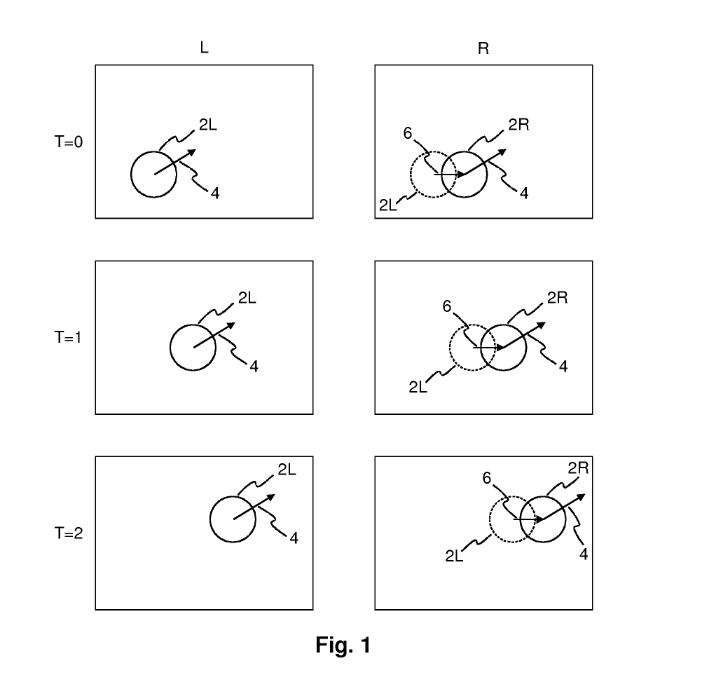

FIG. 1 is a simplified sequence of frames showing a moving object, i.e. the image of the moving object 2L in a left video stream L and an image of this moving object 2R in a right video stream R of 3D video content. By way of an example only, the embodiment refers to a moving object which moves along a trajectory. The trajectory is illustrated by a motion vector 4 in the depicted frames which is a sequence of frames for the points in time T=0 to T=2. Due to the slightly different perspective of the left and right camera of a set of stereo cameras which capture the left and right video stream L, R, the image of the moving object 2L, 2R has slightly different positions in the respective pairs of frames. In the frames of the right channel R, the position of the object 2L in the left channel L is represented by an object 2L drawn in dashed line. The difference in the position of the object 2L in the left channel L and the position of the object 2R in the right channel R is the disparity 6. According to the example in FIG. 1, the object moves fronto parallel and the left and right camera of the stereo camera rig are tightly synchronized. Accordingly, the disparity 6 is a constant vector for each pair of frames. In other words, for every moment in time (T=0 . . . T=2), the disparity 6 is a constant vector.

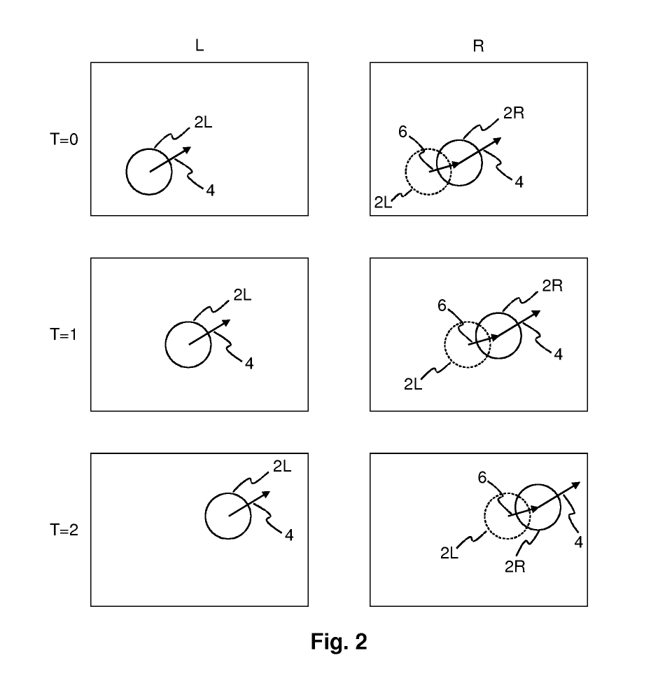

In FIG. 2, there is a sequence of frames showing the same moving object as in FIG. 1. However, this time there is a synchronization mismatch between the left and right video stream L, R. Accordingly, the disparity 6 between the left image of the object 2L and the right image of the object 2R differ by a disparity 6 which is different compared to the disparity 6 in the sequence of frames in FIG. 1. The disparity vector 6 is slightly greater than the disparity vector 6 in the sequence of FIG. 1, because the synchronization mismatch is +Δt for the right video stream R. Further, due to the fact, the motion vector 4 of the object has a horizontal and a vertical component there is a vertical component in the disparity vector 6, too. A vertical component of the disparity 6 is a strong hint to a synchronization mismatch and vertical disparities are well known to cause visual fatigue and are therefore undesired in 3D video content. However, despite of the fact that the vertical component of the disparity 6 is a hint for a temporal synchronization mismatch, it is not possible for the shown example to safely determine the synchronization mismatch by analyzing the disparity 6 alone. It is impossible to discriminate between the assumed scenario that there is a synchronization mismatch between the left and right video stream L, R and a misalignment between the left and right camera (capturing the left and right video stream L, R) of the stereoscopic camera pair. This is because the vertical component of the disparity 6 is constant over time and may be due to a negative tilt of the right camera, for example.

In order to eliminate this ambiguity, the method according to an embodiment of the invention compares the motion vector 4 of the object 2L, 2R in a first sequence of frames with the motion vector 4 of the object 2L, 2R in the second sequence of frames. By analyzing the variation of the motion vector 4 a temporal synchronization mismatch may be determined. For example, the object 2L, 2R may perform a steady movement in the first sequence of frames and may change the motion vector 4, for example by acceleration or deceleration or by a change of direction of movement, in the second sequence of frames.

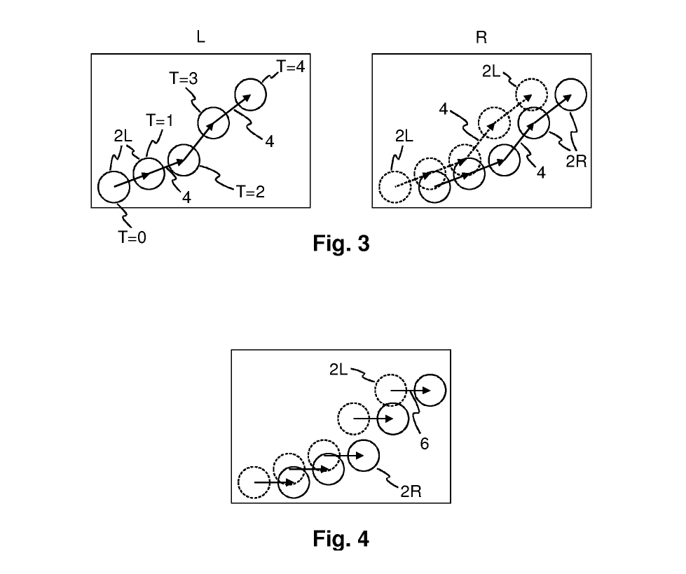

In FIG. 3, there is an object 2L, 2R performing a steady movement during a first number of frames, i.e. the first three frames (T=0 . . . T=2) and which accelerates and changes its direction of movement in the second number of frames, i.e. the following frames (T=3, T=4). For the sake of clarity, the respective positions of the image of the object 2L in the left video stream L and in the right video stream R are presented in one single frame only. Further, for clarity reasons, only some of the object images 2L, 2R are given reference numerals. The change in movement of the object 2L, 2R is clear from the motion vector 4 which changes over time. In the right video stream R, the position of the object 2L in the left video stream L is illustrated by an object 2L drawn in dashed line.

First, it shall be assumed that the left and right camera is tightly synchronized. Accordingly, the disparity 6 between the image of the object 2L in the left channel L and the image of the object 2R in the right channel R is constant over time, as it is illustrated in FIG. 4.

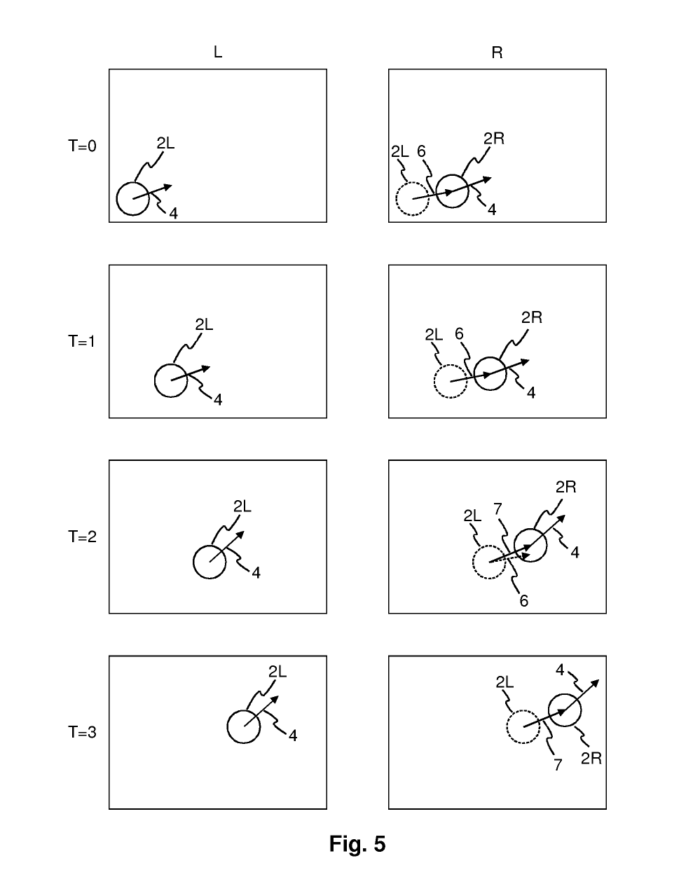

In the image sequence of FIG. 5, there are a plurality of frames of the left video stream L and the right video stream R for a plurality of points in time (T=0 . . . T=3). The object 2L, 2R performs the movement which is known from FIGS. 3 and 4, however, there is a temporal synchronization mismatch between the left and right camera.

At T=0 and T=1, the object 2L, 2R is in uniform motion and accordingly, the motion vector 4 is constant over time. The disparity 6 comprises a vertical component due to the synchronization mismatch between the left video stream L and the right video stream R. At T=2, the object 2L, 2R accelerates and departs from uniform motion also with respect to its direction. Accordingly, the motion vector 4 at T=2 has a different direction and a greater absolute value. The corresponding frames of the left video stream L and the right video stream R at T=2 have a disparity 7 which is different from the disparity 6 for the frames at T=0 and T=1. This is due to the temporal synchronization mismatch of +Δt for the right video stream R. The difference between the disparity 6 in the first number of frames (i.e. in the frames at T=0 and T=1) and the disparity 7 in the second number of frames (i.e. in the frames for T=2 and T=3) is indicative to the synchronization mismatch between the left video stream L and the right video stream R. At T=3, the object continues to move fast and again, a uniform motion may be present. Accordingly, the new disparity 7 is constant in the second number of frames.

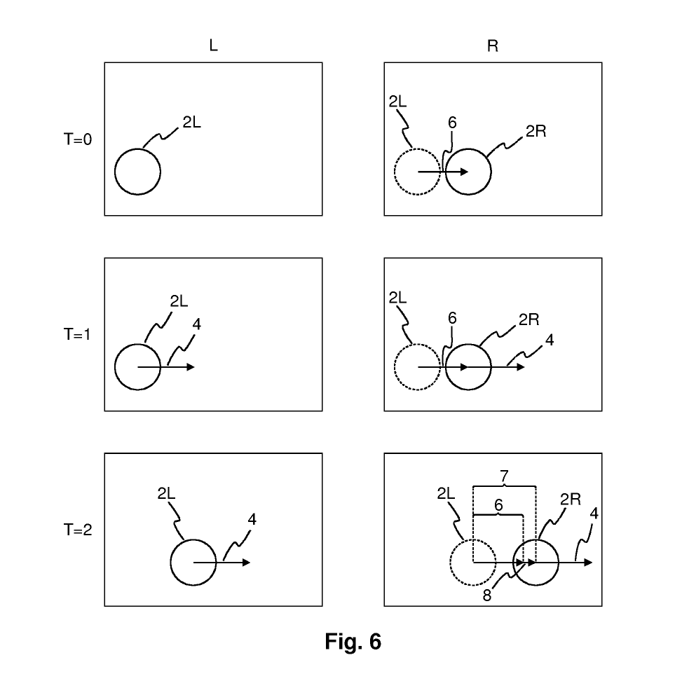

FIG. 6 is a further sequence of simplified frames showing an image of an object 2L in the left channel L and the corresponding image of the object 2R in the right channel R. In the pairs of frames at T=0 and T=1, the object 2L, 2R is at rest and accordingly, there is a constant disparity 6 between the left image of the object 2L and the right image of the object 2R. However, at T=1, the object 2L, 2R starts to move and in the pair of frames at T=2 there is an additional disparity 8 which is due to the movement of the object 2L, 2R and the synchronization mismatch between the left video stream L and the right video stream R. This additional disparity 8 is the difference between the disparity 6 for the first number of frames (i.e. for the frames at T=0 and T=1) and the disparity 7 in the second number of frames (by way of an example, this second number of frames comprises the pair of frames at T=2 only). Again, the synchronization mismatch may be determined by analyzing the change of the motion vector 4 (which changes from zero to a value significantly greater than zero) in two frames and by comparing it with the disparity values for these two frames.

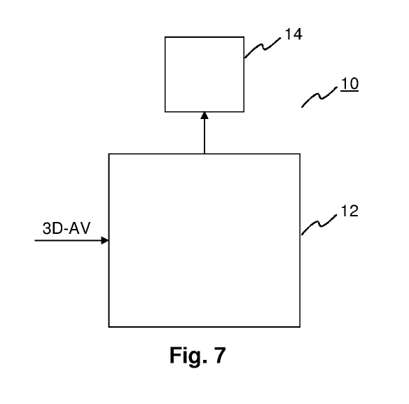

FIG. 7 is a simplified video processing apparatus 10 comprising a processing unit 12 for performing the method according to aspects of the invention. Further, the video processing apparatus 10 comprises a display unit 14. The video processing apparatus 10 may be configured in that the processing unit 12 receives 3D video content (3D-AV) and performs an automated detection of a temporal synchronization mismatch in the 3D video content (3D-AV). For quality control, the video processing apparatus 10 may be configured to display a result of the detection of the temporal synchronization mismatch at the display unit 14 and an optional reproduction of the video content. Accordingly, an operator may check the quality of the automated synchronization mismatch detection and if necessary may adjust the synchronization mismatch manually.

Although the invention has been described hereinabove with reference to specific embodiments, it is not limited to these embodiments and no doubt further alternatives will occur to the skilled person that lie within the scope of the invention as claimed.

1. A method for detecting a temporal synchronization mismatch between at least a left and a right video stream of 3D video content, the method comprising the steps of:
determining a motion vector for a group of pixels in consecutive frames of the left or the right video stream,
determining a corresponding disparity for said group of pixels in the left or the right video stream,
wherein the motion vector and the disparity are determined for a first number of frames and a subsequent second number of frames of the left or the right video stream,
comparing the motion vector of the group of pixels in the first number of frames with the motion vector of said group of pixels in the second number of frames and
upon detection of a variation of the motion vector:
comparing the disparity of the group of pixels which has been determined for the first number of frames with the disparity which has been determined for the second number of frames, wherein a deviation of the disparity is indicative to the synchronization mismatch.

2. The method according to claim 1, wherein the motion vector or the disparity is determined by two dimensional block matching or by feature point tracking.

3. The method according to claim 1, wherein for a variation of the motion vector having a vertical component which is substantially greater than zero, the synchronization mismatch is determined by dividing the vertical component of the deviation in disparity by the variation of the vertical component of the motion vector.

4. The method according to claim 1, wherein for a variation of the motion vector having a horizontal component which is substantially greater than zero, the method further comprises the steps of:
determining a type of camera movement,
wherein for a camera pan, the method further comprises the step of:
determining the synchronization mismatch by dividing the deviation in the horizontal component of the disparity by the variation of the horizontal component of the motion vector.

5. The method according to claim 1, wherein for a variation of the motion vector having a horizontal component which is substantially greater than zero, the method further comprises the steps of:
determining a type of camera movement,
wherein for a horizontal camera displacement, the method further comprises the step of:
determining the synchronization mismatch by dividing the product of the deviation in disparity and a base line of a stereo camera arrangement which has been applied for capturing the 3D video content by the product of a speed of the camera movement and the disparity in the first number of frames.

6. The method according to claim 1, wherein for a variation of the motion vector having a horizontal component which is substantially greater than zero, the method further comprises the steps of:
determining a type of movement for an object,
wherein for a fronto parallel movement of the object, the method further comprises the step of:
determining the synchronization mismatch by dividing the variation of the horizontal disparity by the deviation of the horizontal component of a motion vector of the object.

7. The method according to claim 1, further comprising the steps of:
determining a plurality of motions vectors for a plurality of groups of pixels in consecutive frames of the left or the right video stream and
determining a plurality of corresponding disparities for said plurality of groups of pixels in the left or the right video stream,
wherein the motion vectors and the disparities are determined for a first number of frames and a subsequent second number of frames of the left or the right video stream,
comparing the motion vectors for said plurality of groups of pixels in the first number of frames with the motion vectors of said plurality of groups of pixels in the second number of frames and
upon detection of a variation of the motion vectors:
comparing the disparities which have been determined for the first number of frames with disparities which have been determined for the second number of frames, wherein a preliminary synchronization mismatch is determined by comparing the deviation of the disparities with the variation of the motion vectors and
calculating a median of said preliminary synchronization mismatches so as to determine the overall synchronization mismatch.

8. A video processing apparatus for detecting a temporal synchronization mismatch between at least a left and a right video stream of 3D video content, wherein the video processing apparatus is configured to:
determine a motion vector for a group of pixels in consecutive frames of the left or the right video stream,
determine a disparity for the group of pixels in the left or the right video stream,
wherein the motion vector and the disparity are determined for a first number of frames and a subsequent second number of frames of the left or the right video stream,
compare the motion vector for said group of pixels in the first number of frames with the motion vector) for said group of pixels in the second number of frames,
wherein upon detection of a variation of the motion vector, the video processing apparatus is configured to:
compare the disparity which has been determined for the first number of frames with the disparity which has been determined for the second number of frames, wherein a deviation of the disparity is indicative to the synchronization mismatch.
